(19) United States
(12) Patent Application Publication
(10) Pub. No.: US 2019/0152763 A1
(43) Pub. Date: May 23, 2019

(54) SADDLE LINER

(71) Applicant: Justyna Thomson, Lakeland, FL (US)

(72) Inventor: Justyna Thomson, Lakeland, FL (US)

(21) Appl. No.: 15/987,886

(22) Filed: May 23, 2018

Related U.S. Application Data
(60) Provisional application No. 62/510,170, filed on May 23, 2017.

(51) Int. Cl. B68C 1/12

(52) U.S. Cl. CPC B68C 1/12

(57) ABSTRACT

Described are saddle liners formed from 100% fine grade Merino wool felt material with a thickness of about 3.5 mm, and a density of about 0.35 g/cubic centimeter. The saddle liners can be formed to be compatible with saddles of various equestrian disciplines or activities.

### RELATED APPLICATIONS

This application claims the benefit of U.S. Provisional Application No. 62/510,170, entitle “Saddle Liner,” and filed on May 23, 2018, which is incorporated herein by reference in its entirety.

### TECHNICAL FIELD

Some implementations relate generally to equestrian gear, and more particularly, to saddle liners for equestrian activities.

### OVERVIEW

There are three components commonly used to prepare a horse to be ridden by a rider in a saddle. First, a lightweight blanket (or saddle liner) is placed directly on the horse's back. Next, with some saddles (e.g., Western), a thicker firm pad with varying features is placed over the blanket or saddle liner. Finally, a discipline specific saddle (e.g., Western, English, dressage, jumping, hunting, etc.) is placed over the pad and secured to the horse.

The first layer blanket or saddle liner has traditionally been made of a lightweight mixed fiber knit fabric manufactured by knitting yarn using well known techniques. One disadvantage of a knit blanket is that, when subject to repeated use, the knit fabric may wear unevenly to a point of no longer being useful. Further, the uneven wear of knit blankets may cause pressure from the rider to be unevenly distributed on the horse's back, which can cause the horse to develop skin irritation and deep tissue soreness. Also, currently existing saddle liners/blankets may be inefficient at moisture wicking and may become hot. See FIG. 4 showing a photo comparison of a regular wool blanket and a saddle liner in accordance with the present disclosure. The finer fibers of the Merino wool felt saddle liner as disclosed herein can permit much more effective moisture absorption. Less moisture and better airflow can mean less heat production and retention on the horse's back. Further, heat and moisture can often cause skin irritations on the horse.

Some implementations were developed in light of the above-mentioned problems and limitations.

### BRIEF DESCRIPTION OF THE DRAWINGS

FIG. 1 is a photograph of an example saddle liner configured for Western saddle riding in accordance with some implementations.

FIG. 2 is a photograph of an example saddle liner configured for English saddle riding in accordance with some implementations.

FIG. 3 is a photograph of an example Western saddle liner placed onto a horse in accordance with some implementations.

FIG. 4 is a photograph showing a comparison of a horse's back after being ridden with a saddle liner in which half of the saddle liner is a 100% Merino wool liner made in accordance with the disclosed subject matter and the other half of the liner consists of a conventional knit wool fabric liner.

FIG. 5 is a diagram of an example saddle liner for an English saddle in accordance with some implementations.

### DETAILED DESCRIPTION

In general, some implementations include a saddle liner that is made from a Merino wool felt material having specific properties that have been discovered by the present inventor to yield unexpected results when used as a saddle liner. The Merino wool saddle liner as disclosed herein can be made for use with any of the various types of discipline specific saddles used for equestrian activities.

Felt is a non-woven cloth that is produced by matting, condensing and pressing wool fibers. Felt has been used in various applications including garments and construction materials. Merino wool fibers are some of the finest wool fibers (e.g., having a typical fiber diameter between 17 and 24 microns). Merino wool fibers are relatively soft and have a higher elasticity than some other wools, which helps felt produced from Merino wool have an overall stronger structure as compared to felt form some other types of wool.

Further, the present inventor has discovered that the fibers of fine grade Merino wool felt absorb moisture and help transfer moisture away for evaporation better than felt made from other fibers. This feature of fine Merino wool felt can help keep a horse dryer and cooler than some traditional saddle liners. Further, Merino wool may exhibit antimicrobial properties as some microorganisms may prefer a smooth positively charged surface, whereas Merino wool fibers have a scaly, negatively charged surface.

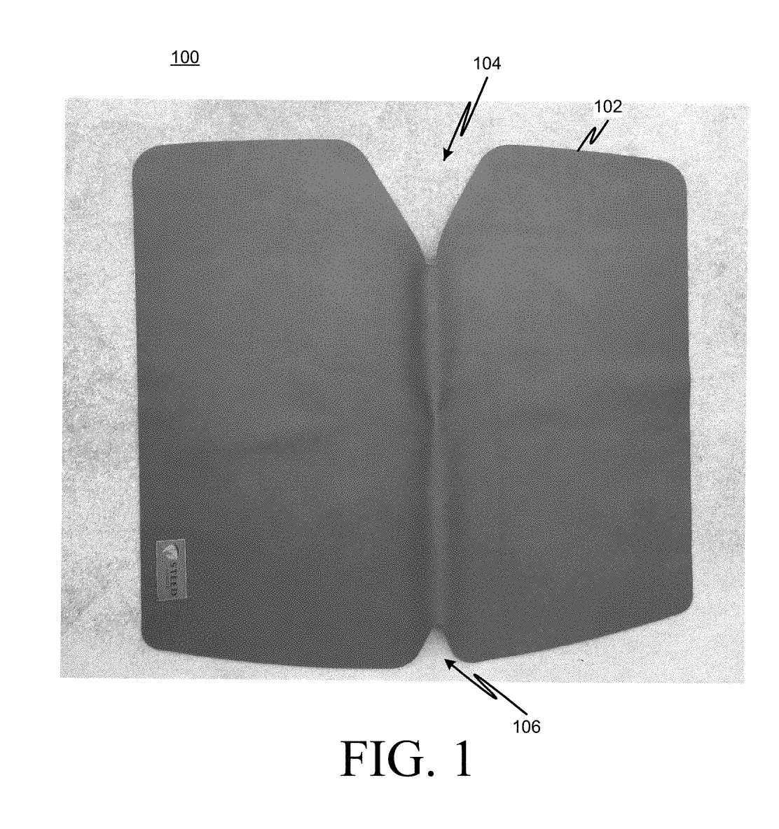

FIG. 1 is a photograph of an example saddle liner 100 configured for Western saddle riding in accordance with some implementations. The saddle liner 100 includes a body portion 102 having a first (or neck) recess 104 and a second (or back) 106 recess. The saddle liner 100 body portion 102 is symmetrical about an axis passing from the first recess to the second recess (e.g., along the axis where the back the horse would be located when the saddle liner is placed on the horse). The saddle liner 100 can be formed from 100% Merino wool felt (e.g., felt made from 100% fine grade Merino wool) having characteristics that have been discovered by the present inventor to be desirable for saddle liners and which present unexpected results. For example, the Merino wool felt can have a thickness of about 3.5 mm and a density of about 0.35 g/cubic centimeter. The saddle liner 100 can be made from fine grade Merino wool, which includes wool having a fiber diameter of about 22 microns or less or about 17-24 microns, etc. In some implementations of a saddle liner for a Western saddle, example dimensions of the saddle liner can be about 30″×32″.

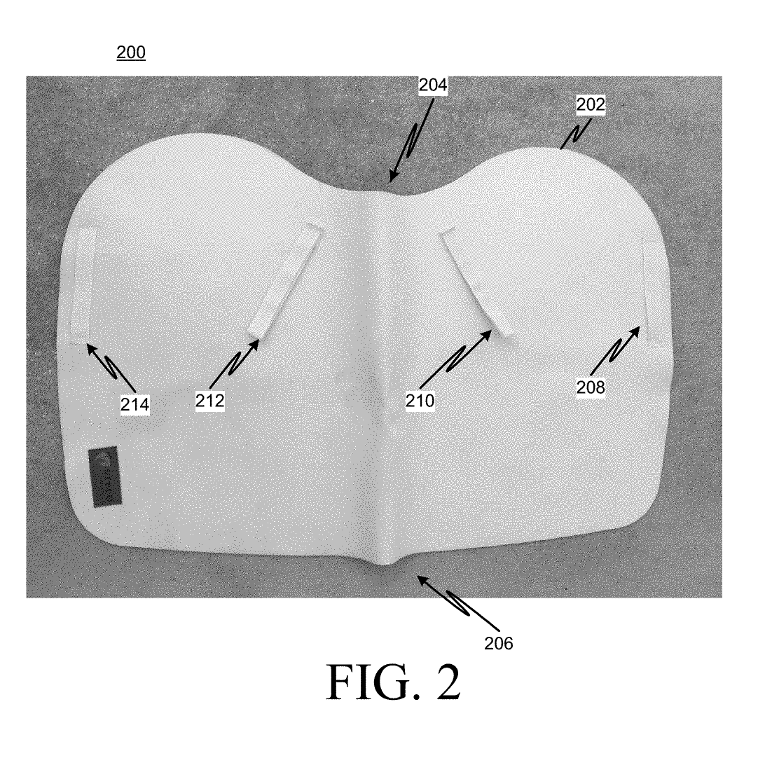

FIG. 2 is a photograph of an example saddle liner 200 configured for English saddle riding in accordance with some implementations. The saddle liner 200 includes a body portion 202 having a neck recess 204 and back protrusion 206. The saddle liner 200 also includes attachment points 208-214 that are configured to secure the saddle liner to the saddle to prevent the saddle liner from slipping. The attachment points may be used for English and other discipline specific saddles in which the saddle contacts the saddle liner directly and no saddle pad is used between the saddle liner and the saddle. The attachment points (208-214) can be made of nylon or other suitable material. The saddle liner 200 body portion 202 is symmetrical about an axis passing from the first recess 204 to the back recess 206 (e.g., along the axis where the back the horse would be located when the saddle liner is placed on the horse). In some implementations of a saddle liner for an English saddle, example dimensions of the saddle liner for English saddles can include a drop of about 19″ and a spine of about 23″.

The saddle liner 200 can be formed from 100% Merino wool felt (e.g., felt made from 100% fine grade Merino wool) having characteristics that have been discovered by the present inventor to be desirable for saddle liners and which present unexpected results. For example, the Merino wool felt can have a thickness of about 3.5 mm and a density of about 0.35 g/cubic centimeter. The saddle liner 200 can be made from fine grade Merino wool, which includes wool having a fiber diameter of about 22 microns or less or about 17-24 microns, etc.

During research and testing for the disclosed saddle liner, the present inventor evaluated numerous Merino wool felts of various characteristics and invented the disclosed saddle liners based on this research, testing, and new and unexpected results of certain specifications of Merino wool felt. For example, thicknesses tested and observations noted included the following:
2.5 mm, which was found to be too thin and the saddle liner formed from this thickness did not stay in place well under the pad and saddle.
3.0 mm, which provided adequate thickness and sturdiness, but still slipped under pad and saddle.
3.5 mm, discovered to perform best with regard to thickness/sturdiness, no slippage, and conforms well to the back of a horse.
4.0 mm, stiffer and less conformable to horse's back, also provided too much padding.
4.5 mm, too thick, not enough flexibility to form over horse's back.

Also, various Merino wool densities were evaluated and observations noted, including the following:
0.20 g/cm³—too weak, light stretching pulled felt out of shape, some pilling, appearance of unevenness in felt cohesion, and very good moisture absorption.
0.30 g/cm³—adequate density, some stretch, slight appearance of unevenness of felt cohesion, and very good moisture absorption.
0.35 g/cm³—good density, no stretch with good flexibility, even felt cohesion, and good moisture absorption.
0.40 g/cm³—good density, no stretch with fair flexibility, even felt cohesion, and poor moisture absorption.
0.50 g/cm³—strong density, no stretch, poor flexibility, even felt cohesion, very poor moisture absorption.

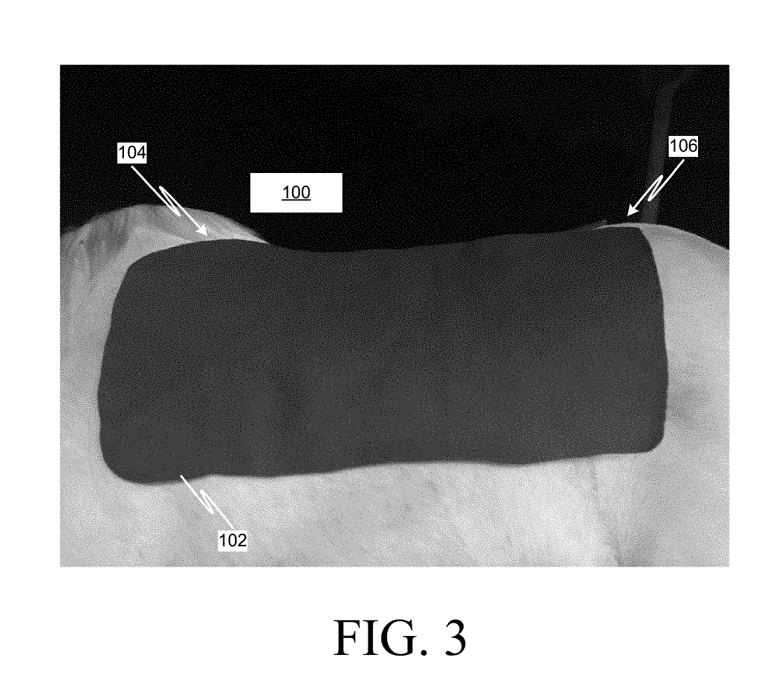

FIG. 3 is a photograph of an example Western saddle liner placed onto a horse in accordance with some implementations. FIG. 3 shows the saddle liner 100 including the body portion 102, a first (or neck) recess 104, and the second (or back) 106 recess.

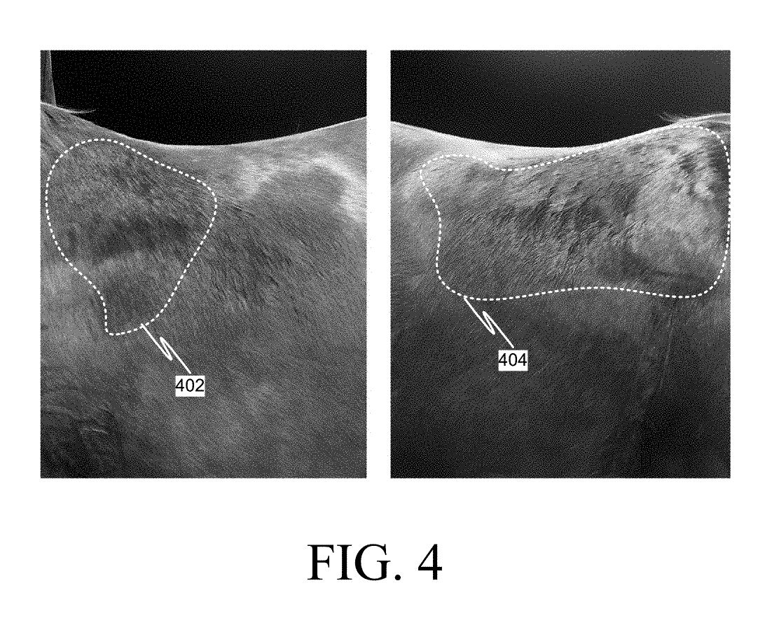

FIG. 4 is a photograph showing a comparison of a horse's back after being ridden with a saddle liner in which half of the saddle liner is a Merino wool liner made in accordance with the disclosed subject matter and the other half of the liner consists of a conventional knit fabric liner.

The image on the left shows a sweat region 402 surround roughly by a dotted line. This is the side of the saddle liner that included an implementation of the disclosed subject matter (i.e., a 100% Merino wool felt liner as described herein).

The image on the right shows a sweat region 404 surround roughly by a dotted line. This is the side of the saddle liner that included a traditional wool saddle liner.

As can be seen in FIG. 4, the sweat area 402 that developed under the saddle liner half that included an implementation of disclosed subject matter is substantially smaller than the sweat area 404 that developed under the half that included a conventional saddle liner. Further, not only is the wet area larger on 404, the hair pattern is rougher and raised due to higher saturation of sweat. The example shown in FIG. 4 helps illustrate a key feature of 100% Merino wool felt and its ability to wick moisture and regulate temperature better than other types of wool. Merino sheep have adapted over thousands of years to produce wool that is capable of withstanding weather extremes. It is the application of a combination of the unique properties of 100% Merino wool and the felt properties (e.g., thickness, density, etc.) discovered by the present inventor, to a saddle liner that makes it possible to achieve the functional difference shown in FIG. 4.

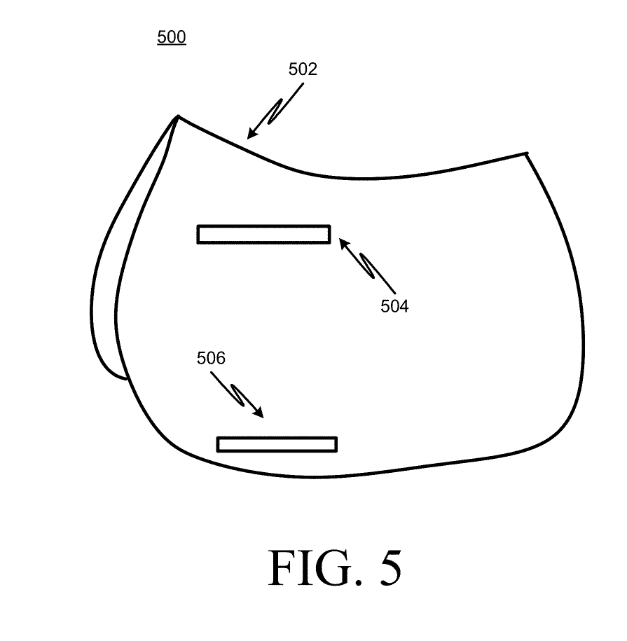

FIG. 5 is a diagram of an example English saddle liner 500 in accordance with some implementations. The saddle liner 502 can be formed from 100% Merino wool felt and manufactured to the following specifications: felt can have a thickness of about 3.5 mm and a density of about 0.35 g/cubic centimeter, and the saddle liner can include a drop of about 19″ and a spine of about 23″. The saddle liner 502 can include attachment points 504 and 506 on one side with corresponding attachment straps (not shown) on the other side of the saddle liner having symmetrical dimensions and placement location. The attachment points 502 and 504 can be made from nylon or other suitable material.

It will be appreciated that English and Western saddle liner examples are shown for illustration purposes and that other saddle liner shapes can be made according to this disclosure for any of the various discipline specific saddles used in equestrian activities. Further, the dimensions of the saddle liners and saddle liner materials described above are for illustration of some implementations of the disclosed subject matter. Some implementations can include thicker liners (e.g., for the Western saddle liner version) of 6 mm, 8 mm, or 12 mm, for example. Also, the density of the felt for the thicker Merino wool felt can be adjusted accordingly (e.g., reduced) to provide more flexibility.

It is, therefore, apparent that there is provided, in accordance with the various embodiments disclosed herein, Merino wool felt saddle liners.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A saddle liner comprising:
a body formed from Merino wool felt, wherein a thickness of the Merino wool felt is about 3.5 mm, and wherein a density of the Merino wool felt is about 0.35 g/cubic centimeter;
wherein the body includes a first end that is oriented toward a horse's neck when the saddle liner is placed on the horse, and a second end that is oriented towards a horse's hind end when the saddle liner is placed on the horse; and
wherein the first end includes a first recess configured to accommodate the horse's neck.

2. The saddle liner of claim 1, wherein the second end includes a second recess, smaller than the first recess, to accommodate the horse's back.

3. The saddle liner of claim 1, wherein the second end includes a protrusion.

4. The saddle liner of claim 1, wherein the Merino wool felt is formed from 100% fine grade Merino wool.

5. The saddle liner of claim 1, wherein the Merino wool felt is formed from 100% Merino wool having a fiber diameter measuring less than about 22 microns in diameter.

6. The saddle liner of claim 1, further comprising a plurality of attachment points configured for securing the saddle liner to a saddle.

7. The saddle liner of claim 1, wherein the saddle liner is formed to have a drop of about 19 inches and a spine of about 23 inches.

8. The saddle liner of claim 1, wherein the Merino wool felt has a thickness of about 3.5 mm and a density of about 0.35 g/cubic centimeter.
